(19) United States
(12) Patent Application Publication
(10) Pub. No.: US 2026/0267248 A1
(43) Pub. Date: Sep. 10, 2026

(54) TONER, IMAGE FORMING APPARATUS, IMAGE-FORMED PRODUCT, AND METHOD FOR PRODUCING TONER

(71) Applicant: Konica Minolta, Inc., Tokyo (JP)

(72) Inventors: Yusuke TAKIGAURA, Tokyo (JP); Junya UEDA, Tokyo (JP)

(21) Appl. No.: 19/556,119

(22) Filed: Mar. 4, 2026

(30) Foreign Application Priority Data
Mar. 10, 2025 (JP) 2025-037431

(51) Int. Cl. G03G 9/087

(52) U.S. Cl. CPC G03G 9/08711; G03G 9/08755; G03G 9/08782

(57) ABSTRACT

A toner that includes a binder resin, at least one metal element selected from an alkali metal, an alkaline earth metal, and aluminum, and a sulfur element. When the mass % of the at least one metal element based on the total mass of the toner as measured by X-ray fluorescence analysis is A mass % and the mass % of the sulfur element based on the total mass is B mass %, the toner satisfies 0.8≤A/B.

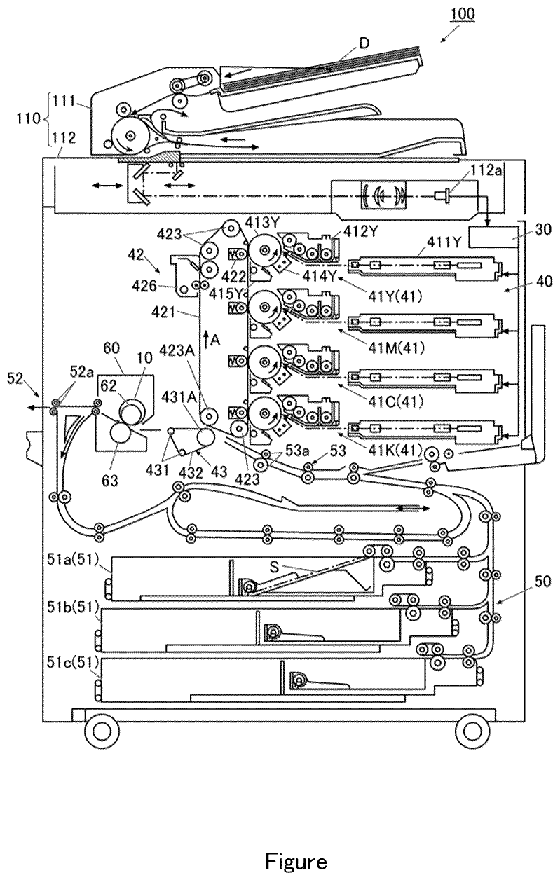

### CROSS REFERENCE TO RELATED APPLICATIONS

Japanese Patent Application No. 2025-037431 filed on Mar. 10, 2025, including description, claims, drawings, and abstract the entire disclosure is incorporated herein by reference in its entirety.

### BACKGROUND

### Technological Field

The present invention relates to a toner, an image forming apparatus including the toner, an image-formed product formed with the toner, and a method for producing the toner.

### Description of the Related Art

In recent years, a toner for use in printing by an electrophotographic method has been required to have low-temperature fixability to be fixed on a recording medium at a low temperature from the viewpoint of energy saving, and development of the toner has been advanced. For example, Japanese Unexamined Patent Publication No. 2016-066018 discloses a toner excellent in low-temperature fixability.

### SUMMARY

Since the toner is dispersed in a particle form without aggregation, an intended image can be formed by an electrophotographic method. However, when the toner particles are aggregated to form clumps, the toner becomes difficult to be stirred and charged, the charge amount is reduced, and the toner is not held by the carrier. As a result, a phenomenon called fogging may occur in which the toner is transferred to an unintended portion of a recording medium such as a sheet. In particular, a low-temperature fixing toner tends to aggregate, and fogging tends to occur. In order to prevent the aggregation of toner and the occurrence of fogging, it is effective to incorporate a compound having a negative charge, such as a sulfonic acid group, into the toner to increase the electrostatic repulsion. However, in this case, negative charges are increased on the surface of the image after the toner is fixing on the recording medium. As a result, when recording media on which images have been formed are stacked, the recording media are more likely to stick to each other due to electrostatic force.

An object of the present invention is to provide a toner capable of suppressing occurrence of sticking caused by electrostatic force between recording media on which images are formed while suppressing occurrence of fogging. Another object of the present invention is to provide an image forming apparatus including the toner. Another object of the present invention is to provide an image-formed product formed with the toner. Another object of the present invention is to provide a method for producing the toner.

The present invention inventors have studied to achieve the above objects and have found that the above objects can be achieved by the following means. The present invention relates to the following toner, an image forming apparatus including the toner, an image-formed product obtained by using the toner, and a method for producing the toner.

A toner reflecting an aspect of the present invention in order to realize at least one of the aforementioned objects is a toner that includes: a binder resin; at least one metal element selected from an alkali metal, an alkaline earth metal, and aluminum; and a sulfur element; in which
when a mass % of the at least one metal element based on a total mass of the toner as measured by X-ray fluorescence analysis is A mass % and a mass % of the sulfur element based on the total mass is B mass %, the toner satisfies 0.8≤A/B.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

The FIGURE is a schematic configurational view which illustrates an example of an image forming apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

A preferred embodiment of the present invention is described below, but the present invention is not limited to the following embodiment.

The toner according to the embodiment of the present invention contains a binder resin, at least one metal element selected from an alkali metal, an alkaline earth metal, and aluminum, and a sulfur element. The toner satisfies 0.8≤AB when A mass % is defined as a mass % of the at least one metal element based on the total mass of the toner as measured by X-ray fluorescence analysis and B mass % is defined as a mass % of the sulfur element by mass based on the total mass.

The reason why the above-described objects are achieved by the toner according to the embodiment is not clear, but it is presumed as follows.

As described above, as the content of the sulfonic acid group or the like having a sulfur element, which is easily negatively charged in the toner, increases, the chargeability of the toner surface increases, and the electrostatic repulsive force increases. As a result, aggregation of toner particles in the image forming apparatus (developing device) is suppressed, and fogging can be suppressed during image formation. However, when the amount of the sulfur element in the toner increases, the charge amount on the surface of an image after the toner is fixed increases. Therefore, there is a high possibility that the recording media on which the images are formed by the toner as described above are electrostatically stuck to each other when the recording media are stacked. Therefore, it is presumed that inclusion of a metal element such as an alkali metal—which readily conducts charge in the toner—facilitates leakage of the charge during fixing and reduces the residual charge on the image surface, thereby suppressing electrostatic sticking.

To be specific, when 0.8≤A (metal element)/B (sulfur element) is satisfied, it is possible to inhibit sticking of image-formed products while inhibiting aggregation of toner particles to inhibit fogging. Note that the lower limit of A/B may be 0.9≤A/B, 1.2≤A/B, 1.5≤A/B, or 1.7≤A/B. Furthermore, the upper limit of A/B is not particularly limited, but is, for example, 2.5≥A/B or 2.3≥A/B or 2≥A/B.

Note that the “toner” is toner for developing an electrostatic latent image. The toner includes toner base particles. The toner base particles may be included in the toner as toner particles having an external additive on their surface. The “toner image” refers to a state in which toner is aggregated in an image shape.

### [Configuration of Toner]

The following describes the configuration of toner base particles included in the toner.

### <Toner Base Particle>

The toner according to the present embodiment includes toner base particles. The toner base particle contain a binder resin. Furthermore, the toner base particle may also contain a release agent, a coloring agent, and a charge control agent, as needed. The toner (toner base particle) contains a sulfur element and a metal element as described above. In the present embodiment, the sulfur element contained in the toner (toner base particle) is derived from a surfactant and a polymerization initiator used when a binder resin (binder resin fine particles) is synthesized in the production of the toner. Further, in the present embodiment, the metal element contained in the toner (toner base particles) is derived from an aggregating agent for aggregation of the synthesized binder resin fine particles in the production of the toner. Hereinafter, the surfactant containing a sulfur element, the polymerization initiator containing a sulfur element, and the aggregating agent containing a metal element will be described.

### (Surfactant Containing Sulfur Element)

The surfactant containing a sulfur element is used when the binder resin fine particles are produced by the emulsion aggregation method. Examples of the surfactant having a sulfonic acid group include sodium alkyl sulfonate, sodium alkylbenzene sulfonate, and sodium alkyl ether sulfonate. More specifically, examples of the surfactant include sodium dodecyl sulfate, sodium dodecylbenzene sulfonate, and sodium polyoxyethylene lauryl ether sulfate.

### (Polymerization Initiator Containing Sulfur Element)

The polymerization initiator containing a sulfur element is used when a vinyl resin (e.g., a styrene-acrylic resin) is synthesized. The polymerization initiator preferably contains a sulfonic acid group (sulfur element). When a vinyl resin is synthesized using a polymerization initiator containing a sulfur element, the aggregation of the toner is suppressed, and the occurrence of fogging tends to be suppressed. This is presumed to be because when the vinyl resin is synthesized using a polymerization initiator containing a sulfur element, the sulfur element (sulfonic acid group) is incorporated into a vinyl resin fine particle via a chemical bond. As a result, chargeability is uniformly imparted to the entire toner, which is presumed to be useful for suppression of fogging. Therefore, at least a part of the sulfur element is preferably derived from the polymerization initiator (for example, potassium persulfate).

Examples of the polymerization initiator containing a sulfur element include potassium persulfate.

The content of the sulfur element (B mass %) may be 0.1 mass % or more, 0.2 mass % or more, 0.3 mass % or more, 0.4 mass % or more, or 0.5 mass % or more, based on the total mass of the toner. The upper limit of the content of the sulfur element (B mass %) may be, for example, 0.7 mass % or less or 0.6 mass % or less based on the total mass of the toner.

### (Aggregating Agent Containing Metal Element)

The aggregating agent containing a metal element is used in production of the toner base particles. Toner base particles are obtained by aggregation of plurality of resin fine particles, which will be described in more detail below. An aggregating agent is used at this time. It is sufficient that the metal element is at least one member selected from alkali metals, alkaline earth metals, and aluminum. These metal elements cause the negative charge of the toner fixed to a recording medium (e.g., a sheet) to leak, thereby suppressing sticking when the toner is fixed and the recording media are stacked. Examples of the aggregating agent containing a metal element include salts of alkali metals, salts of alkaline earth metals, and salts of aluminum. Specifically, examples of the aggregating agent containing a metal element include sodium chloride, potassium chloride, calcium chloride, magnesium chloride, aluminum chloride, and aluminum sulfate. Among these, as the aggregating agent containing a metal element, an aggregating agent containing magnesium is preferable.

The content of the metal element (A mass %) can be, for example, 0.2 mass % or more, 0.3 mass % or more, 0.4 mass % or more, or 0.5 mass % or more based on the total mass of the toner. The upper limit of the content of the metal element (A mass %) can be, for example, 0.7 mass % or less, or 0.6 mass % or less. The content (mass %) of the Mg element based on the total mass of the metal elements is preferably 30 mass % or more. The mass % of the Mg element based on the total mass of the metal elements may be 20 mass % or more, or 40 mass % or more. The upper limit of the mass % of the Mg element based on the total mass of the metal elements may be, for example, 70 mass % or less, or 60 mass % or less.

Hereinafter, the binder resin which is a main component constituting the toner will be described. In addition, a release agent, a coloring agent, and a charge control agent, which are other components that the toner may have, will also be described.

### (Binder Resin)

The binder resin binds the toner to a recording medium.

Examples of the binder resin include vinyl resins and polyester resins. Examples of the polyester resin include amorphous polyester resins and crystalline polyester resins.

The binder resin in the toner can be detected by, for example, a pyrolysis gas chromatography/mass spectrometry (GC/MS) method.

An amorphous polyester resin is a resin that does not exhibit a clear endothermic peak when subjected to differential scanning calorimetry (DSC). On the other hand, a crystalline resin is a resin that shows a clear endothermic peak when subjected to differential scanning calorimetry (DSC).

Hereinafter, each of the vinyl resin and the polyester resin (crystalline polyester resin and amorphous polyester resin) will be described in detail.

### <Vinyl Resin>

The vinyl resin refers to an amorphous resin among polymers obtained from monomers having a vinyl group. Hereinafter, monomers that can be used to obtain the vinyl resin will be described, and the resin is preferably a styrene-acrylic resin obtained by polymerizing (1) a styrene-based monomer and (2) a (meth)acrylic acid-based monomer described below. The following monomers may be used alone or in combination of two or more types thereof. The polymerization may be carried out using a polymerization initiator as described above.

### (1) Styrene-Based Monomer

Examples of the styrene-based monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene and the like. Further, the examples may include monomers having styrene structures such as derivatives thereof. Among these, styrene is preferable.

### (2) (Meth)acrylic Acid-Based Monomer

Examples of the (meth)acrylic acid-based monomer include (meth)acrylic acid and (meth)acrylic acid ester-based monomers. Examples of the (meth)acrylic acid ester-based monomer include methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate and the like. In addition, the examples may include monomers having a (meth)acrylic group, such as derivatives thereof. Among these, methacrylic acid and n-butyl acrylate are preferable.

### (3) Vinyl Ester-Based Monomer

Examples of the vinyl ester-based monomer include vinyl propionate, vinyl acetate, and vinyl benzoate.

### (4) Vinyl Ether-Based Monomer

Examples of the vinyl ether-based monomer include vinyl methyl ether and vinyl ethyl ether.

### (5) Vinyl Ketone-Based Monomer

Examples of the vinyl ketone-based monomer include vinyl methyl ketone, vinyl ethyl ketone, and vinyl hexyl ketone.

### (6) N-vinyl Compound-Based Monomer

Examples of the N-vinyl compounds include N-vinylcarbazole, N-vinylindole, and N-vinylpyrrolidone.

### (7) Others

Examples of other vinyl monomers include compounds (e.g., vinylnaphthalene and vinylpyridine), acrylic acid derivatives (e.g., acrylonitrile, methacrylonitrile, and acrylamide), and methacrylic acid derivatives.

The content of the vinyl resin is preferably in a range of 30 to 60 mass %, and more preferably in a range of 50 to 60 mass %, based on the total mass of the binder resin.

### <Polyester Resin>

The polyester resin is obtained by a polymerization reaction of a carboxylic acid monomer having a valency of two or more (polycarboxylic acid) and an alcohol monomer having a valency of two or more (polyhydric alcohol). For the polymerization, a known esterification catalyst may be used. Examples of the polyester resin include amorphous polyester resins and crystalline polyester resins. Hereinafter, each of the amorphous polyester resin and crystalline polyester resin will be described.

### <<Amorphous Polyester Resin>>

The amorphous polyester resin is a resin exhibiting amorphous properties among polyester resins. Specifically, a polyester resin that does not have a clear endothermic peak during temperature increase in an endothermic curve obtained by differential scanning calorimetry (DSC) can be referred to as the amorphous polyester resin. Here, the “clear endothermic peak” refers to a peak having a half value width of 15° C. or less in an endothermic curve when the temperature is increased at a temperature increase rate of 10° C./min.

The polycarboxylic acid is a compound having two or more carboxy groups in one molecule. Examples of polycarboxylic acid monomers that can be used in the synthesis of amorphous polyesters include phthalic acid, isophthalic acid, terephthalic acid, trimellitic acid, naphthalene-2,6-dicarboxylic acid, malonic acid, mesaconic acid, dimethyl isophthalate, fumaric acid, dodecenylsuccinic acid, and 1,10-dodecanedicarboxylic acid. Among these, dimethyl isophthalate, terephthalic acid, fumaric acid, dodecenylsuccinic acid, and trimellitic acid are preferable.

The polyhydric alcohol is a compound having two or more hydroxy groups in one molecule. The polyhydric alcohol is preferably a linear aliphatic polyhydric alcohol or an alicyclic polyhydric alcohol. Further, the polyhydric alcohol may be a dihydric alcohol or a trihydric alcohol.

The number of carbon atoms of the linear aliphatic moiety of the linear aliphatic polyhydric alcohol is preferably 5 or more, more preferably within a range of 5 to 10, and still more preferably within a range of 5 to 8.

Examples of the linear aliphatic polyhydric alcohol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol and the like. These may be used alone or in combination of two or more types thereof.

The alicyclic polyhydric alcohol is not particularly limited. The number of carbon atoms of the alicyclic polyhydric alcohol is preferably 5 or more, more preferably within a range of 5 to 10, and still more preferably within a range of 5 to 8. When the number of carbon atoms is 5 or more, the polarity difference between the main chain of the amorphous polyester and the main chain of the crystalline polyester can be further reduced, and as a result, both the low-temperature fixability and the hot offset resistance can be improved.

Examples of the alicyclic polyhydric alcohol include 1,4-cyclohexanediol, 1,4-cyclohexanedimethanol, 1,3-cyclohexanedimethanol, and 1,2-cyclohexanedimethanol. These may be used alone or in combination of two or more types thereof.

The other polyhydric alcohols are not particularly limited, and examples thereof include propylene glycol, 2,3-butanediol, diethylene glycol, triethylene glycol, neopentyl glycol, dipropylene glycol, polyethylene glycol, polypropylene glycol, glycerin, sorbitol, 1,4-sorbitan and trimethylolpropane. These may be used alone or in combination of two or more types thereof.

Examples of catalysts that can be used in the synthesis of amorphous polyesters include metal-containing compounds, phosphorous compounds, phosphoric acid compounds, and amine compounds. Examples of the metal contained in the metal-containing compound include sodium, lithium, magnesium, calcium, aluminum, zinc, manganese, antimony, titanium, tin, zirconium, and germanium. These may be used alone or in combination of two or more types thereof.

Specific example of the tin-containing compound include dibutyltin oxide, tin octylate, tin dioctylate, and salts thereof.

Examples of the titanium-containing compound include titanium alkoxide, titanium acylate, and titanium chelate. Examples of the titanium alkoxide include tetra-normal-butyl titanate (Ti(O-n-Bu)₄), tetraisopropyl titanate, tetramethyl titanate, tetrastearyl titanate, and the like. Examples of the titanium acylate include polyhydroxy titanium stearate. Examples of the titanium chelate include titanium tetraacetylacetonate, titanium lactate, and titanium triethanolaminate.

An example of the germanium-containing compound is germanium dioxide.

Examples of the aluminum-containing compound include polyaluminum hydroxide, aluminum alkoxide, and tributyl aluminate.

The polymerization conditions for synthesis of the amorphous polyester are not particularly limited. The polymerization temperature is, for example, within a range of 150 to 250° C. The polymerization time is preferably within a range of 0.5 to 10 hours. During the polymerization, the pressure in the reaction system may be reduced, as needed.

The glass transition temperature Tg of the amorphous polyester is preferably within a range of 25 to 60° C. and more preferably within a range of 35 to 55° C. from the viewpoint of achieving both sufficient low-temperature fixability and heat-resistant storage property. The glass transition temperature Tg can be measured using a differential scanning calorimeter, for example, “Diamond DSC” (manufactured by PerkinElmer, Inc).

The weight average molecular weight Mw of the amorphous polyester is not particularly limited, but is preferably in the range of 10,000 to 100,000. The weight average molecular weight Mw can be measured using gel permeation chromatography (GPC).

The content of the amorphous polyester resin is preferably 30 mass % or more, and more preferably 50 mass % or more, based on the total mass of the binder resin, from the viewpoint of satisfactory low-temperature fixability. The upper limit of the content of the amorphous polyester resin is, for example, 100 mass % or less or 70 mass % or less based on the total mass of the binder resin.

### <<Crystalline Polyester Resin>>

The crystalline polyester resin is a resin exhibiting crystallinity among polyester resins. In other words, the crystalline polyester resin is a resin having a melting point. Specifically, the crystalline polyester resin has a clear endothermic peak during temperature increase in an endothermic curve obtained by differential scanning calorimetry (DSC). Here, the “clear endothermic peak” refers to a peak having a half value width of 15° C. or less in an endothermic curve when the temperature is increased at a temperature increase rate of 10° C./min.

The crystalline polyester can be synthesized by esterifying a polycarboxylic acid and a polyhydric alcohol through polycondensation using a known esterification catalyst. The polycarboxylic acid and the polyhydric alcohol are not particularly limited.

Examples of polycarboxylic acids include saturated aliphatic dicarboxylic acids, unsaturated aliphatic dicarboxylic acids, and unsaturated aromatic dicarboxylic acids.

Examples of the saturated aliphatic dicarboxylic acids include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-Undecanedicarboxylic acid, 1,12-odecanedicarboxylic acid, 1,13-tridecanedicarboxylic acid, 1,14-tetradecanedicarboxylic acid, 1,16-hexadecanedicarboxylic acid, 1,18-octadecanedicarboxylic acid and the like.

Examples of the unsaturated aliphatic dicarboxylic acids include methylenesuccinic acid, fumaric acid, maleic acid, 3-hexenedioic acid, 3-octenedioic acid, dodecenylsuccinic acid and the like.

Examples of the unsaturated aromatic dicarboxylic acids include phthalic acid, terephthalic acid, isophthalic acid, t-butylisophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, anthracenedicarboxylic acids and the like.

Lower alkyl esters or acid anhydrides of these dicarboxylic acids may be used as the polycarboxylic acid.

These may be used alone or in combination of two or more types thereof.

Other examples of the polycarboxylic acid having 3 or more valences include trimellitic acid and pyromellitic acid.

Examples of polyhydric alcohols include saturated aliphatic diols, unsaturated aliphatic diols, and aromatic diols.

Examples of the saturated aliphatic diols include ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18 octadecanediol, 1,20-eicosanediol, neopentyl glycol and the like.

Examples of the unsaturated aliphatic diol include 2-butene-1,4-diol, 3-butene-1,4-diol, 2-butyne-1,4-diol, 3-butyne-1,4-diol, 9-octadecene-7,12-diol and the like.

Examples of the aromatic diol include bisphenols, and alkylene oxide adducts of bisphenols. Examples of the bisphenols include bisphenol A and bisphenol F. Examples of the alkylene oxide adducts of bisphenols include ethylene oxide adducts of bisphenols and propylene oxide adducts of bisphenols.

Derivatives of these diols may be used as the polyhydric alcohol.

As the combination of the polycarboxylic acid and the polyhydric alcohol, a combination of an aliphatic dicarboxylic acid having 6 to 14 carbon atoms and an aliphatic diol having 6 to 14 carbon atoms is preferable from the viewpoint of heat-resistant storage property and rising property of the charge amount.

Description will be given from the viewpoint of heat-resistant storage property.

The smaller the number of carbon atoms in the polycarboxylic acid and polyhydric alcohol, the easier the toner base particles melt, improving the low-temperature fixability. On the other hand, when the toner base particles are made too fusible, heat-resistant storage property is more likely to deteriorate. For example, when the heat-resistant storage property is low, the toner tends to aggregate in a case where the toner is stored in a state of being heated in a developing device. Therefore, when the number of carbon atoms of each of the polycarboxylic acid and the polyhydric alcohol is within the range of 6 to 14, both heat-resistant storage property and low-temperature fixability of the toner can be achieved.

Description will be given from the viewpoint of the rising property of the charge amount.

The polarity of a crystalline polyester decreases as the number of carbon atoms in the polycarboxylic acid and polyhydric alcohol increases, making crystalline polyester less compatible with other resins and resulting in larger domains in the binder resin. On the other hand, the polarity of a crystalline polyester increases as the number of carbon atoms of the polycarboxylic acid and the polyhydric alcohol decreases, making the crystalline polyester more compatible with other resins and resulting in promotion of finely dispersion in the binder resin.

When the dispersion state of the crystalline polyester is appropriate, the distance between domains becomes short. When the distance between the domains decreases, the resistance to the charge transfer in the toner particles decreases, and the charge amount easily rises. Therefore, when the number of carbon atoms of each of the polycarboxylic acid and the polyhydric alcohol is in the range of 6 to 14, the rising property of the charge amount can be improved.

The crystalline polyester of the present embodiment is a modified crystalline polyester modified with at least one member selected from styrene compounds and (meth)acrylic acid esters. The crystalline polyester is preferably modified to such an extent that the properties thereof are not impaired.

Note that monomers used in a styrene-acrylic resin described below can be applied for the styrene compounds and the (meth)acrylic acid ester as the modifying agent.

For synthesis of the crystalline polyester, any of the catalysts usable for synthesis of the amorphous polyester described above can be used.

The polymerization conditions for synthesis of the crystalline polyester are not particularly limited. Among them, the polymerization temperature is preferably within a range of 70 to 250° C. The polymerization time is preferably within a range of 0.5 to 10 hours. During the polymerization, the pressure in the reaction system may be reduced, as needed.

The melting point of the crystalline polyester is not particularly limited, but is preferably in the range of 70 to 95° C. When the melting point is 70° C. or higher, heat resistance can be improved, and when the melting point is 95° C. or lower, low-temperature fixability can be improved. The melting point can be measured using a differential scanning calorimeter, for example, “Diamond DSC” (manufactured by PerkinElmer, Inc).

The weight average molecular weight Mw of the crystalline polyester is preferably within a range of 1000 to 29000. The weight average molecular weight Mw can be measured by gel permeation chromatography (GPC).

The content of the crystalline polyester is preferably in a range of 5 to 30 mass % and more preferably in a range of 10 to 20 mass % based on the total mass of the binder resin.

### (Release Agent)

The toner base particle may contain a release agent, as needed. When the toner base particle contains a release agent, the fixing separability can be improved. The release agent is not particularly limited, and various known waxes can be used.

Examples of the release agent include branched-chain hydrocarbon waxes, long-chain hydrocarbon-based waxes, dialkyl ketone-based waxes, ester-based waxes, and amide-based waxes.

Examples of the branched-chain hydrocarbon wax include polyolefin waxes (polyethylene wax, polypropylene wax, and the like), microcrystalline wax, and the like. Examples of the long-chain hydrocarbon-based wax include paraffin wax and Sasol wax. Examples of the dialkyl ketone-based wax include distearyl ketone. Examples of the ester-based wax include carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, distearyl maleate, stearyl stearate and the like. Examples of the amide-based wax include ethylenediamine behenylamide and trimellitic acid tristearylamide. These may be used alone or in combination of two or more types thereof.

Examples of commercially available products of the release agent include “HNP-0190, HNP-51, and FNP-0090” (manufactured by NIPPON SEIRO CO., LTD) and “C80” (manufactured by Sasol Limited).

The melting point Tm of the release agent is preferably within a range of 70 to 91° C. When the melting point Tm is equal to or lower than 91° C., the release agent easily exudes from the toner particles at the time of fixing, and the amount of the release agent on the surfaces of the images increases. As a result, the separability from the fixing roller is improved, and the low-temperature fixability can be improved. In addition, when the melting point Tm is equal to or higher than 70° C., the release agent is less likely to be disposed on the surface of the toner particles during production due to the difference in viscosity between the release agent and the binder resins, and thus the heat-resistant storage property of the toner particles is improved.

The melting point Tm of the release agent is determined by differential scanning calorimetry (DSC), for example, according to the following procedure.

A differential scanning calorimeter “DSC7000X” (manufactured by Hitachi High-Tech Corp.) and a thermal analyzer controller “AS3/DX” (manufactured by Hitachi High-Tech Corp.) are used. An AI autosampler sample vessel φ6.8 H2.5 mm (manufactured by Hitachi High-Tech Corp.) is charged with 0.5 mg of the measurement sample and sealed with an AI autosampler cover (manufactured by Hitachi High-Tech Corp.). This is set in a sample holder of “AS3/DX”.

The measurement conditions are as follows: a measurement temperature of 0 to 200° C., a temperature increase rate of 10° C./min, and a temperature lowering rate of 10° C./min. The temperature is controlled in the order of Heat-Cool-Heat, and the data from the first Heat is analyzed. For the reference measurement, an empty aluminum pan is used. Through the above procedure, the melting point of the crystalline resin contained in the measurement sample can be measured. The crystalline resin includes the above-described crystalline polyester in addition to the release agent. Therefore, in a case where the measurement sample is a toner, a peak derived from the crystalline polyester may also be detected in addition to that of the release agent. The melting point Tm of the release agent is defined as the peak top temperature of the heat endothermic peak derived from the crystalline polymer in the first Heat. In a case where a plurality of endothermic peaks is detected, the melting point Tm of the release agent is defined as the peak top temperature of the peak on the highest temperature side among the endothermic peaks.

The content of the release agent is preferably within a range of 1 to 30 parts by mass, and more preferably within a range of 5 to 20 parts by mass, relative to 100 parts by mass of the binder resin, from the viewpoint of fixing separability.

### (Coloring Agent)

The toner base particles may contain a coloring agent, as needed. As the coloring agent, known coloring agents can be used. Examples of the coloring agent include known inorganic coloring agents and organic coloring agents. Specifically, examples of the coloring agent include carbon black, magnetic powder, organic pigments, inorganic pigments, and dyes.

The content of the coloring agent is preferably in the range of 1 to 30 mass % and more preferably in the range of 2 to 20 mass % based on the total mass of the binder resin.

### (Charge Control Agent)

The toner base particles may contain a charge control agent, as needed. The chargeability of the toner base particles can be improved by containing a charge control agent. Examples of the charge control agent include known compounds such as nigrosine dyes, metal salts of naphthenic acid, metal salts of higher fatty acids, alkoxylated amines, quaternary ammonium salts, azo metal complexes, and metal salts of salicylic acid.

The content of the charge control agent is preferably within a range of 0.1 to 5.0 parts by mass relative to 100 parts by mass of the binder resin.

### [Structure of Toner Base Particle]

The structure of the toner base particle according to the present embodiment is not particularly limited. A single layer structure including only a toner base particle that contains the above-described constituent components may be used. Alternatively, the toner may have a multilayer structure such as a core-shell structure including a toner base particle as a core particle and a shell layer, in which toner base particle contains the above-described constituent components and the shell layer covers the surface of the core particle.

The shell layer does not have to cover the entire surface of the core particle, and thus the core particle may be partially exposed. The cross section of the core-shell structure can be confirmed by known observation means such as a transmission electron microscope (TEM) and a scanning probe microscope (SPM).

In the core-shell structure, characteristics such as a glass transition temperature, a melting point, and hardness can be made different between the core particle and the shell layer, and the toner base particle can be designed according to the purpose. For example, the shell layer can be formed by aggregation and fusing a resin having a relatively high glass transition temperature on the surface of a core particle containing a binder resin, a coloring agent, a release agent, and the like and having a relatively low glass transition temperature.

From the viewpoints of suppression of fogging and the like, the release agent may be present in the vicinity of the surface of the toner base particle without being exposed on the surface of the toner base particle.

In the toner base particle according to the present embodiment, the binder resin of the core particle preferably contains the crystalline polyester, and more preferably contains both the amorphous polyester and the crystalline polyester. As a result, both low-temperature fixability and hot offset resistance can be achieved. In a case where the toner base particles contain a vinyl resin, the vinyl resin is preferably contained in the core particles.

In the toner base particle according to the present embodiment, it is preferable that the binder resin of the shell layer mainly contains the amorphous polyester. Covering the surface of the toner base particle with the amorphous polyester can prevent the surface of the toner base particle from excessively softening even in a high-temperature environment and can thus further improve hot offset resistance. In addition, when the shell layer contains the amorphous polyester, the affinity between the shell layer and the core particle also increases. As a result, it is considered that the crystalline polyester in the core particles is less likely to be exposed and thus the hot offset resistance can be further improved.

The average circularity of the toner base particles is preferably in a range of 0.935 to 0.995, more preferably in a range of 0.945 to 0.990, and still more preferably in a range of 0.955 to 0.980. When the average circularity is within the above range, individual toner particles are less likely to be crushed, the charge amount becomes stable, and a high-quality image is obtained. Note that the average circularity can be measured using, for example, a flow-type particle image analyzer “FPIA-3000” (manufactured by Sysmex Corporation).

As a specific method for measuring the average circularity, the toner base particles are wetted with an aqueous surfactant solution and subjected to ultrasound dispersion for 1 minute to be dispersed. Thereafter, using the FPIA-2100, measurements are performed under the measurement conditions of HPF (high magnification imaging) mode at an appropriate density of 4,000 HPF detections. The circularity is calculated by the following equation.

Circularity=(perimeter of a circle having the same projected area as a particle image)/(perimeter of a particle projection image) (Equation):

Furthermore, the average circularity is an arithmetic average value obtained by summing the circularities of the respective particles and dividing the sum by the total number of measured particles.

### [External Additive]

Toner base particles with an external additive added thereto may be used as toner particles (toner). Addition of the external additive to the toner base particles enables control of the chargeability, fluidity, anti-blocking performance, and the like of the resulting toner particles.

The external additive is not particularly limited, and examples thereof include inorganic oxide particles, inorganic stearate compound particles, inorganic titanate compound particles, and zirconia particles. These may be used alone or in combination of two or more types thereof.

Examples of the inorganic oxide particles include silica particles, alumina particles, titanium oxide particles, zinc oxide particles, chromium oxide particles, cerium oxide particles, antimony oxide particles, tungsten oxide particles, tin oxide particles, tellurium oxide particles, manganese oxide particles, and boron oxide particles.

Examples of the inorganic stearate compound particles include aluminum stearate particles and zinc stearate particles.

Examples of the inorganic titanate compound particles include strontium titanate particles and zinc titanate particles.

The content of the external additive is preferably in a range of 0.05 to 5 parts by mass and more preferably in a range of 0.1 to 3 parts by mass relative to 100 parts by mass of the toner base particles. In a case of using a plurality of external additives, the total content of the external additives is preferably within the above-described range.

Among these, the external additive is preferably silica particles or strontium titanate particles.

### [Method for Producing Toner]

The method for producing the toner base particles is not particularly limited, and examples thereof include known methods such as kneading and pulverization, suspension polymerization, emulsion aggregation, dissolution suspension, polyester elongation, and dispersion polymerization methods. Among these, the emulsion aggregation method is preferable from the viewpoint of uniformity of the particle diameter, controllability of the shape, and ease of formation of the core-shell structure. Hereinafter, the emulsion aggregation method will be described.

The method for producing an electrostatic charge image developing toner using an emulsion aggregation method preferably includes the following steps (I) and (II).
(I) a step of preparing a dispersion liquid of binder resin particles by emulsion polymerization
(II) a step of mixing a dispersion liquid of coloring agent particles and the dispersion liquid of the binder resin particles to aggregate, associate, and fuse the coloring agent particles and the binder resin particles, thereby forming toner base particle

When a vinyl resin serving as the binder resin is synthesized by emulsion polymerization, a polymerization initiator having a sulfur element (sulfonic acid group) is preferably used as the polymerization initiator.

The binder resin particles may be composite particles. The composite particles are formed of two or more layers of resin having different compositions. The binder resin particles can be formed by, for example, emulsion polymerization, mini-emulsion polymerization, or phase inversion emulsification method. The particles of the binder resin can be formed by combining some of these methods. Among these, an emulsion polymerization method is preferable from the viewpoint that the shape of the binder resin particles can be controlled. Thereafter, the binder resin particles formed by emulsion polymerization are preferably dispersed with the use of a surfactant or a dispersion liquid stabilizer to prepare a dispersion liquid.

In the emulsion aggregation method, first, various dispersion liquids of components to be contained in the toner base particles are mixed. Specifically, a dispersion liquid of coloring agent particles and a dispersion liquid of binder resin particles are mixed. When necessary, a dispersion liquid of particles of a release agent or the like may be mixed. In addition, in a case where the toner base particles do not contain a coloring agent, a dispersion liquid of particles of the coloring agent is not necessarily mixed. Next, an aggregating agent is added to the mixed liquid to aggregate and associate the toner base particles until the toner base particles have a desired particle diameter. Thereafter or at the same time, fusion between particles of the binder resin is performed and shape control is performed, thereby forming toner base particle.

Toner base particles having a core-shell structure can be obtained by the emulsion aggregation method. Specifically, first, various particles of components to be contained in the core particles are aggregated, associated, and fused to form the core particles. Next, a dispersion liquid of particles of a binder resin for the shell layer is added to the dispersion liquid of the core particles, and the particles of the binder resin for the shell layer are aggregated, associated, and fused to the surfaces of the core particles, thereby forming the shell layers covering the surfaces of the core particles.

A method for drying the toner base particles is not particularly limited. From the viewpoint of productivity, the drying method is preferably lyophilization, flash jet drying, vibration-type fluidized drying, or the like.

Examples of the method for adding the external additive to the toner base particles include a dry method in which the external additive is added in the form of a powder to the dried toner base particles. Examples of the mixing device include mechanical mixing devices such as a Henschel mixer and a coffee mill.

### [Developer]

The toner of the present embodiment may be used alone as a magnetic or non-magnetic one component developer for developing an electrostatic charge image. In addition, the toner of the present embodiment may be mixed with carrier particles and used as a two-component developer for developing an electrostatic charge image. By using the two-component developer, chargeability stability can be improved. As a result, an image before fixing can be uniformly formed, and image quality and low-temperature fixability are excellent.

As the carrier particles, for example, magnetic particles formed of a conventionally known material can be used. Examples of the magnetic particles include metal particles such as iron, ferrite, and magnetic particles. Other examples include particles of an alloy of any one of these metals and a metal such as aluminum or lead. The carrier particles are particularly preferably ferrite particles.

As the carrier particles, coated carrier particles in which the surfaces of magnetic particles are coated with a coating agent such as a resin, or dispersed-type carrier particles in which a magnetic fine powder is dispersed in a binder resin may be used. The carrier particles are preferably coated carrier particles from the viewpoint of suppressing adhesion of the carrier particles to a photoreceptor.

The volume-based median diameter of the carrier particles is preferably within a range of 20 to 100 μm, and more preferably within a range of 25 to 80 μm. The volume-based median diameter of the carrier particles can be measured with, for example, a laser diffraction particle size distribution analyzer “HELOS” (manufactured by SYMPATEC GmbH) equipped with a wet disperser.

An appropriate amount of the carrier particles may be mixed with the toner of the present embodiment. Examples of a mixing device used for mixing include Nauta mixers, W-type mixers, and V-type mixers.

In the two-component developer, the content of the toner is preferably in a range of 8 to 10 mass % based on the total mass of the two-component developer (the total mass of the toner and the carrier).

### [Image Forming Apparatus]

An image forming apparatus according to an embodiment of the present invention includes a developer storage section for storing the above-described developer. The image forming apparatus according to the present embodiment preferably includes a two-component developer for developing an electrostatic charge image. Specifically, the image forming apparatus according to the present embodiment includes the above-described two-component developer for developing an electrostatic charge image in a developing device of an electrophotographic image forming apparatus. Examples of the electrophotographic image forming apparatus include known electrophotographic image forming apparatuses.

An image forming apparatus in which the two-component developer for developing an electrostatic charge image of the present embodiment is suitably used will be described. Hereinafter, the “two-component developer for developing an electrostatic charge image” is also simply referred to as a “developer”.

For example, the image forming apparatus may be a four cycle-type image forming apparatus constituted by four types of color developing devices of yellow, magenta, cyan and black and one electrophotographic photoreceptor. Alternatively, the image forming apparatus may be a tandem-type image forming apparatus including four types of color developing devices of yellow, magenta, cyan, and black, and four electrophotographic photoreceptors provided for the respective colors.

The developer of the embodiment can be used as a developer for any of yellow, magenta, cyan, and black.

The FIGURE is a schematic configuration diagram illustrating an example of an image forming apparatus 100 according to an embodiment. The image forming apparatus 100 illustrated in FIGURE includes an image reader 110, an image processor 30, an image former 40, a sheet conveyer 50, and a fixing device 60.

The image former 40 includes image forming units 41Y, 41M, 41C, and 41K that form images using toners of respective colors of Y (yellow), M (magenta), C (cyan), and K (black). These units all have the same configuration except for the stored toner, and therefore, hereinafter, the symbol representing the color may be omitted.

The image forming unit 41 includes an exposure device 411, a developing device 412, an electrophotographic photoreceptor (image bearing member) 413, a charging device 414, and a drum cleaning device 415. The charging device 414 is, for example, a corona charging device. The charging device 414 may be a contact charging device that brings a contact charging member (a charging roller, a charging brush, a charging blade, or the like) into contact with the electrophotographic photoreceptor 413 to charge the electrophotographic photoreceptor 413. The exposure device 411 includes, for example, a semiconductor laser as a light source, and a light deflection device (polygon motor) that irradiates the electrophotographic photoreceptor 413 with laser light corresponding to an image to be formed. The electrophotographic photoreceptor 413 is a negatively chargeable organic photoreceptor having photoconductivity. The electrophotographic photoreceptor 413 is charged by the charging device 414.

The developing device 412 is a developing device of a two-component development method. The developing device 412 includes a developing container, a developing roller, a partition wall, a conveyance roller, and a stirring roller. The developing container stores a developer. The developing roller (magnetic roller) is rotatably disposed at an opening portion of the developing container. The partition wall partitions the inside of the developing container in such a way that the developer can pass therethrough. The conveyance roller conveys the developer on the opening portion side in the developing container toward the developing roller. The stirring roller stirs the developer in the developing container.

### EXAMPLES

Hereinafter, the present invention will be specifically described with reference to examples, but the present invention is not limited to the examples. Note that in the following examples, operations were performed at room temperature (25° C.) unless otherwise specified. Further, unless otherwise specified, “%” and “part (s)” mean “mass %” and “parts by mass”, respectively.

Production of toners (toner base particle) of examples and comparative examples will be described below. In the production of toner base particles, first, three resin fine particle dispersion liquids are obtained. Three resin particle dispersion liquids are an amorphous polyester resin fine particle dispersion liquid (i.e., dispersion liquid of amorphous polyester resin fine particles), a crystalline polyester resin fine particle dispersion liquid (i.e., dispersion liquid of crystalline polyester resin fine particles), and a styrene-acrylic resin fine particle dispersion liquid (i.e., dispersion liquid of styrene-acrylic resin fine particles) as a vinyl resin fine particle dispersion liquid. A coloring agent fine particle dispersion liquid (i.e., dispersion liquid of coloring agent fine particles) is also obtained. Next, using the obtained three resin fine particle dispersion liquids and the coloring agent fine particle dispersion liquid, the fine particles of each resin fine particle dispersion liquid are aggregated with an aggregating agent to obtain toner base particles. An external additive is added to the toner base particles to obtain toner particles (toner). Hereinafter, first, preparation of the fine particles of each resin fine particle dispersion liquid will be described, and next, production of toner base particles by aggregation of the fine particles will be described. Next, production of toner particles obtained by adding an external additive to toner base particles will be described. Finally, the production of a developer obtained by adding a carrier to toner particles will be described.

### <Preparation of Amorphous Polyester Resin Fine Particle Dispersion Liquid>

Two types of amorphous polyester resin fine particle dispersion liquids, A1 and A2, were prepared as the amorphous polyester resin fine particle dispersion liquids. Hereinafter, each of the dispersion liquids will be described.

### [Preparation of Amorphous Polyester Resin Fine Particle Dispersion Liquid A1]

A mixed solution of a monomer of a vinyl resin, a monomer having a substituent group reactive with both the amorphous polyester resin and the vinyl resin, and a polymerization initiator as described below was placed in a dropping funnel.

| | |
|---|---|
| Styrene | 80.0 parts by mass |
| n-Butyl acrylate | 20.0 parts by mass |
| Acrylic acid | 10.0 parts by mass |
| Di-t-butyl peroxide (polymerization initiator) | 16.0 parts by mass |

Furthermore, monomers of an amorphous polyester resin as described below were placed in a four-neck flask equipped with a nitrogen introduction tube, a dehydration tube, a stirrer, and a thermocouple, and were heated to 170° C. to be dissolved.

### Polyhydric Alcohol

| | |
|---|---|
| Bisphenol A-ethylene oxide (2 mol) adduct | 114 parts by mass |
| Bisphenol A-propylene oxide (2 mol) adduct | 280 parts by mass |

### Polycarboxylic Acid

| | |
|---|---|
| Terephthalic acid | 55 parts by mass |
| Fumaric acid | 5 parts by mass |
| Dodecenyl succinic acid | 40 parts by mass |

Under stirring, the mixed liquid placed in the dropping funnel was added dropwise to the four-neck flask over 90 minute, and aging was performed for 60 minutes. Thereafter, the unreacted monomers were removed under reduced pressure (8 kPa). Thereafter, Ti(OBu)₄ was added as an esterification catalyst at the content of 0.003 mass % based on the total amount of the polycarboxylic acid component, and the mixture was heated to 235° C. and reacted at normal pressure (101.3 kPa) for 5 hours and then under reduced pressure (8 kPa) for 1 hour. The reaction solution was then cooled to 200° C. and reacted under reduced pressure (20 kPa), after which the solvent was removed to obtain an amorphous polyester resin al. The obtained amorphous polyester resin al had a glass transition temperature of 45° C. and a weight average molecular weight of 8,500.

Next, 108 parts by mass of the amorphous polyester resins al was stirred in 64 parts by mass of methylethyl ketone at 70° C. for 30 minutes to obtain a solution in which the amorphous polyester resin al was dissolved in methylethyl ketone. Then, an aqueous solution was prepared by dissolving sodium polyoxyethylene lauryl ether sulfate as a surfactant containing a sulfur element in 26 parts by mass of ion-exchanged water so that the concentration became 1 mass %. Next, the aqueous solution was added to the above-described solution. Furthermore, 3.4 parts by mass of a 25 mass % aqueous sodium hydroxide solution was added to the solution. Next, this solution was placed in a reaction vessel having a stirrer, and while stirring the solution in the reaction vessel, 270 parts by mass of ion-exchanged water at 70° C. was added dropwise over 70 minutes and mixed. The solution in the reaction vessel became cloudy during the dropwise addition, and an emulsion that became a uniformly emulsified state was obtained after the entire amount was added dropwise.

Subsequently, while the emulsion was kept at 70° C., it was stirred for 1 hour under reduced pressure in a 15 kPa (150 mbar) using a diaphragm pump “V-700” (manufactured by Buchi Labortechnik GmbH) to distill off methylethylketone. As a result, an amorphous polyester resin fine particle dispersion liquid A1 in which the fine particles of the amorphous polyester resin al were dispersed was prepared. The resulting amorphous polyester resin fine particle dispersion liquid A1 had a solid content of 25 mass %. In addition, the particle size of the amorphous polyester resin fine particles in the amorphous polyester resin fine particle dispersion liquid A1 was measured with a particle size distribution analyzer, and as a result, the volume-average particle diameter thereof was 94 nm.

### [Preparation of Amorphous Polyester Resin Fine Particle Dispersion Liquid A2]

In the preparation of the amorphous polyester resin fine particle dispersion liquid A1, sodium polyoxyethylene lauryl ether sulfate containing a sulfur element was used as the surfactant. In contrast, polyoxyethylene distyrenated phenyl ether containing no sulfur element was used as the surfactant in the preparation of the amorphous polyester resin fine particle dispersion liquid A2. Other than that, an amorphous polyester resin fine particle dispersion liquid A2 was obtained in the same manner as the preparation of the amorphous polyester resin fine particle dispersion liquid A1. The solid content of the obtained amorphous polyester resin fine particle dispersion liquid A2 was 25 mass %. In addition, the particle size of the amorphous polyester resin fine particles in the amorphous polyester resin fine particle dispersion liquid A2 was measured with a particle size distribution analyzer, and as a result, the volume-average particle diameter thereof was 94 nm.

### <Preparation of Crystalline Polyester Resin Fine Particle Dispersion Liquid>

For the crystalline polyester resin fine particles, two types of crystalline polyester resin fine particle dispersion liquids, C1 and C2, were prepared. Hereinafter, each of the dispersion liquids will be described.

### [Preparation of Crystalline Polyester Resin Particle Dispersion Liquid C1]

A mixed solution of a monomer of a vinyl resin, a monomer having a substituent group reactive with both the amorphous polyester resin and the vinyl resin, and a polymerization initiator as described below was placed in a dropping funnel.

| | |
|---|---|
| Styrene | 40.0 parts by mass |
| n-Butyl acrylate | 16 parts by mass |
| Acrylic acid | 3.5 parts by mass |
| Di-t-butyl peroxide (polymerization initiator) | 8 parts by mass |

In addition, raw material monomers of a polycondensation resin (crystalline polyester resin: CPEs) unit as described below were put into a four-neck flask equipped with a nitrogen introduction tube, a dehydration tube, a stirrer, and a thermocouple, and heated to 170° C. to be dissolved.

### Polycarboxylic Acid

| | |
|---|---|
| Tetradecanedioic acid: | 400 parts by mass |

### Polyhydric Alcohol

| | |
|---|---|
| 1,4- Butanediol: | 130 parts by mass |

The mixed liquid placed in the dropping funnel was added dropwise to the four-neck flask over 90 minute under stirring, and aging was performed for 60 minutes. Thereafter, the unreacted monomers were removed under reduced pressure (8 kPa). Thereafter, Ti(OBu)₄ was added as an esterification catalyst at the content of 0.003 mass % based on the total amount of the polycarboxylic acid component, and the mixture was heated to 235° C. and reacted at normal pressure (101.3 kPa) for 5 hours and then under reduced pressure (8 kPa) for 1 hour. Next, the reactant was cooled to 200° C. and then reacted for 1 hour under reduced pressure (20 kPa), to obtain crystalline polyester resin (c1). The melting point of the obtained crystalline polyester resin c1 was 77° C.

Next, 174 parts by mass of the obtained crystalline polyester resin c1 was added to 102 parts by mass of methylethyl ketone and stirred at 75° C. for 30 minutes to obtain a solution in which the crystalline polyester resin was dissolved. Then, an aqueous solution was prepared by dissolving sodium polyoxyethylene lauryl ether sulfate containing a sulfur element as a surfactant in 26 parts by mass of ion-exchanged water so that the concentration became 1 mass %. Next, the aqueous solution was added to the above-described solution. Furthermore, 4.6 parts by mass of a 25 mass % aqueous sodium hydroxide solution was added. This solution was placed in a reaction vessel having a stirrer, and while stirring the solution in the reaction vessel, 375 parts by mass of water at 70° C. was added dropwise over 70 minutes and mixed. The solution in the reaction vessel became cloudy during the dropwise addition, and an emulsion that became a uniformly emulsified state was obtained after the entire amount was added dropwise.

Subsequently, while the emulsion was kept at 70° C., it was stirred for 1 hour under reduced pressure in a 15 kPa (150 mbar) using a diaphragm pump “V-700” (manufactured by Buchi Labortechnik GmbH) to distill off methylethylketone. Thereafter, the emulsion was cooled at a cooling rate of 6° C./min to produce a crystalline resin fine particle dispersion liquid C1 in which the fine particles of the crystalline resin c1 were dispersed. The solid content of the fine crystalline resin particle dispersion liquid C1 was 25 mass %. In addition, the particle size of the fine crystalline polyester resin particles in the fine crystalline polyester resin particle dispersion liquid C1 was measured with a particle size distribution analyzer, and as a result, the volume-average particle diameter thereof was 202 nm.

### [Preparation of Crystalline Polyester Resin Fine Particle Dispersion Liquid C2]

In the preparation of the crystalline polyester resin fine particle dispersion liquid C1, sodium polyoxyethylene lauryl ether sulfate containing a sulfur element is used as the surfactant. In contrast, polyoxyethylene distyrenated phenyl ether containing no sulfur element was used as the surfactant in the preparation of the crystalline polyester resin fine particle dispersion liquid C2. Other than that, a crystalline polyester resin fine particle dispersion liquid C2 was obtained in the same manner as in the preparation of the crystalline polyester resin fine particle dispersion liquid C1. The particle size of the crystalline polyester resin fine particles in the obtained crystalline polyester resin fine particle dispersion liquid C2 was measured, and as a result, the volume-average particle diameter thereof was 198 nm.

### <Preparation of Vinyl Resin Fine Particle Dispersion Liquid>

Five types of vinyl polymer fine particle dispersion liquids, S1 to S5, were prepared as vinyl polymer fine particle dispersion liquids. Hereinafter, each of the dispersion liquids will be described.

### [Preparation of Vinyl Resin Fine Particle Dispersion Liquid S1]

### (First Stage Polymerization)

A 5 L reaction vessel equipped with a stirring device, a temperature sensor, a cooling tube, and a nitrogen introduction device was prepared. To the reaction vessel, 8 parts by mass of sodium dodecyl sulfate containing a sulfur element as the surfactant and 3000 parts by mass of ion-exchanged water were added, and the internal temperature was increased to 80° C. while stirring the mixture at a stirring speed of 230 rpm under a nitrogen gas stream. A solution was prepared by dissolving 10 parts by mass of potassium persulfate containing a sulfur element as a polymerization initiator in 200 parts by mass of ion-exchanged water. This solution was added to the reaction vessel, the liquid temperature was again adjusted to 80° C., and a mixed liquid of the following monomers was added dropwise over 1 hour.

| | |
|---|---|
| Styrene | 480.0 parts by mass |
| n-Butyl acrylate | 250.0 parts by mass |
| Methacrylic acid | 68.0 parts by mass |

After the dropwise addition of the mixed solution, the mixture was heated and stirred at 80° C. for 2 hours to polymerize the monomers, thereby preparing a vinyl-based resin particle dispersion liquid s1.

### (Second Stage Polymerization)

A 5 L reaction vessel equipped with a stirring device, a temperature sensor, a cooling tube, and a nitrogen gas introduction device was charged with 1100 parts by mass of ion-exchanged water and 55 parts by mass, in terms of solid fraction, of the vinyl-based resin particle dispersion liquid s1 prepared in the first stage polymerization, and the mixture was heated to 87° C. Thereafter, a mixed liquid in which the following monomers, chain transfer agent, and release agent were dissolved at 85° C. was subjected to mixing and dispersion treatment for 10 minutes with a mechanical disperser CLEARMIX (manufactured by M Technique Co., Ltd.) having a circulation path to prepare a dispersion liquid containing emulsified particles (oil droplets). This dispersion liquid was added to the above 5 L reaction vessel. As a polymerization initiator, 5.4 parts by mass of potassium persulfate containing a sulfur element was dissolved in 103 parts by mass of ion-exchanged water. The solution of the polymerization initiator was added to the reaction vessel, and the system was heated and stirred at 87° C. for 1 hour for polymerization to prepare a vinyl-based resin particle dispersion liquid s1′.

| | | |
|---|---|---|
| Styrene (St) | 256.5 | parts by mass |
| 2-Ethylhexyl acrylate (2-EHA): | 95.3 | parts by mass |
| Methacrylic acid (MAA) | 38.2 | parts by mass |
| Release agent: “FNP0090” (manufactured by | 144.0 | parts by mass |
| NIPPON SEIRO CO., LTD) | | |
| n-Octyl-3-mercaptopropionate (chain transfer | 4.0 | parts by mass |
| agent): | | |

### (Third Stage Polymerization)

To the vinyl-based resin particle dispersion liquid s1′ obtained in the second stage polymerization, a solution including 7.3 parts by mass of potassium persulfate containing a sulfur element as a polymerization initiator dissolved in 157.9 parts by mass of ion-exchanged water was further added. Furthermore, under a temperature condition of 84° C., a mixed liquid of the following monomers and chain transfer agent was added dropwise over 90 minute.

| | | |
|---|---|---|
| Styrene | 370.0 | parts by mass |
| n-Butyl acrylate | 165.0 | parts by mass |
| Methacrylic acid | 40.0 | parts by mass |
| Methyl methacrylate | 47.2 | parts by mass |
| n-Octyl-3-mercaptopropionate | 8.6 | parts by mass |

After the completion of the dropwise addition, the mixture was heated and stirred for 2 hours for polymerization and then cooled to 28° C., to obtain a vinyl-based resin fine particle dispersion liquid S1. The solids content of the vinyl-based resin fine particle dispersion liquid S1 obtained was 30 mass %.

### [Preparation of Vinyl-Based Resin Fine Particle Dispersion Liquids S2 to S5]

Vinyl-based resin fine particle dispersion liquids S2 to S5 were obtained in the same manner as in preparation example S1 of the vinyl-based resin fine particle dispersion liquid except that the types of surfactants, the type of release agent, and the types and amounts of polymerization initiators in the first, second, and third stage polymerizations were changed as described in Table 1.

TABLE 1

| Vinyl resin- | | | | | | | | |
|---|---|---|---|---|---|---|---|---|
| based fine | | | | | | | | |
| particle | First stage polymerization | | | Second stage polymerization | | | Third stage polymerization | |
| dispersion | Surfactant | Polymerization initiator | | Release agent | Polymerization initiator | | Polymerization initiator | |
| liquid No. | Type | Type | Amount | Type | Type | Amount | Type | Amount |
| S1 | Sodium dodecyl | Potassium persulfate | 10 parts | Hydrocarbon | Potassium persulfate | 5.4 parts | Potassium persulfate | 7.3 parts |
| | sulfate | | by mass | (FNP0090) | | by mass | | by mass |
| S2 | Sodium dodecyl | Potassium persulfate | 10 parts | Hydrocarbon | Potassium persulfate | 5.4 parts | 4,4′-Azobis (4- | 7.3 parts |
| | sulfate | | by mass | (FNP0090) | | by mass | cyanovaleric acid) | by mass |
| S3 | Sodium dodecyl | Potassium persulfate | 10 parts | Ester (WEP-5) | Potassium persulfate | 5.4 parts | 4,4′-Azobis (4- | 7.3 parts |
| | sulfate | | by mass | | | by mass | cyanovaleric acid) | by mass |
| S4 | Polyoxyethylene- | 4,4′-Azobis (4- | 10 parts | Hydrocarbon | 4,4′-Azobis (4- | 5.4 parts | 4,4′-Azobis (4- | 7.3 parts |
| | distyrenated | cyanovaleric acid) | by mass | (FNP0090) | cyanovaleric acid) | by mass | cyanovaleric acid) | by mass |
| | phenyl ether | | | | | | | |
| S5 | Sodium dodecyl | Potassium persulfate | 10 parts | Hydrocarbon | Potassium persulfate | 16.8 parts | Potassium persulfate | 22.7 parts |
| | sulfate | | by mass | (FNP0090) | | by mass | | by mass |

### <Preparation of Coloring Agent Fine Particle Dispersion Liquid P1>

To a solution—obtained by adding 226 parts by mass of sodium dodecyl sulfate containing a sulfur element as a surfactant to 1600 parts by mass of ion-exchanged water, 420 parts by mass of copper phthalocyanine (C. I. Pigment Blue 15:3) was gradually added while stirring the solution. The mixture was subjected to a dispersion treatment using a stirring device CLEARMIX (manufactured by M Technique Co., Ltd., “CLEARMIX” is a registered trade mark of the company) to prepare a coloring agent particle dispersion liquid P1. The volume-based median diameter of the colorant particles in the dispersion liquid was 110 nm.

### <Production of Toner Base Particles by Aggregation>

The following materials were charged into a reaction vessel equipped with a stirring device, a temperature sensor, and a cooling tube.

| | |
|---|---|
| Vinyl-based resin fine particle dispersion | 600 parts by mass |
| liquid S1 | |
| Amorphous polyester resin fine particle | 1080 parts by mass |
| dispersion liquid A1 | (first half) |
| Ion-exchanged water | 140 parts by mass |

A 5 mol/L aqueous sodium hydroxide solution was added to a reaction vessel at room temperature (25° C.), and the pH was adjusted to 10. Furthermore, 270 parts by mass of the coloring agent fine particle dispersion liquid P1 was added, and 80 parts by mass of a 50 mass % aqueous solution of magnesium chloride as an aggregating agent was added over 10 minutes at 30° C. under stirring. The resulting dispersion liquid was left to stand for 5 minutes, and then, the temperature was raised to 80° C. over 60 minutes. After the temperature reached 80° C., 360 parts by mass of the crystalline polyester resin fine particle dispersion liquid C1 was added over 20 minutes. The stirring speed was adjusted so that the growth rate of the particle size was 0.01 μm/min. The particles were grown until the volume-based median diameter of the particles measured with Coulter Multisizer 3 (manufactured by Beckman Coulter, Inc) became 6.0 μm.

Next, 240 parts by mass (in terms of solid) (second half) of the amorphous polyester resin dispersion liquid A1 was added over 30 minutes and when the supernatant of the liquid became transparent, an aqueous solution obtained by dissolving 80 parts by mass of sodium chlorite in 300 parts by mass of ion-exchanged water was added, thereby stopping the growth of the particle size. Next, the mixture was stirred at 80° C. to allow fusion of the particles to proceed until the average circularity of the toner particles reached 0.970, and then cooled at a temperature lowering rate of 0.5° C./min or more to lower the liquid temperature to 30° C. or lower.

Next, solid-liquid separation was performed, the dehydrated toner cake was redispersed in ion-exchanged water, and this operation of solid-liquid separation was repeated three times to perform washing. After the washing, the resultant was dried at 35° C. for 24 hours to obtain toner base particles 1.

### Production Examples 2 to 15 of Toner Base Particles

Toner base particles 2 to 15 were obtained in the same manner as in the production of toner base particles 1, except that the respective types and amounts of the amorphous polyester resin fine particle dispersion liquid, the vinyl-based resin fine particle dispersion liquid, the crystalline polyester resin fine particle dispersion liquid, and the aggregating agent were changed as described in Table 2 below in the production of toner base particles 2 to 15. Note that, as described above, the amorphous polyester resin fine particles were added separately in the first half and the second half. Table 2 shows the amount of the amorphous polyester resin added in each of the first half and the second half. Table 2 also shows the mass % of the amorphous polyester resin based on the total mass of the binder resin.

TABLE 2

| | Amorphous polyester resin | | | | | | | | |
|---|---|---|---|---|---|---|---|---|---|
| | fine particle dispersion liquid | | Amorphous | | | Crystalline polyester | | | |
| | | parts by | polyester resin | Styrene-acrylic resin fine | | resin fine particle | | | |
| Toner | | mass First | based on total mass | particle dispersion liquid | | dispersion liquid | | Aggregating agent | |
| base | | half/second | of binder resin | | parts | | parts | | parts |
| particle | No. | half | [mass %] | No. | by mass | No. | by mass | Type | by mass |
| 1 | A1 | 1080/240 | 57.9 | S1 | 600 | C1 | 360 | Aqueous solution of 50 mass | 80 |
| | | | | | | | | % magnesium chloride | |
| 2 | A1 | 1836/204 | 85.0 | — | 0 | C1 | 360 | Aqueous solution of 50 mass | 80 |
| | | | | | | | | % magnesium chloride | |
| 3 | — | 0 | 0 | S1 | 2040 | C1 | 360 | Aqueous solution of 50 mass | 80 |
| | | | | | | | | % magnesium chloride | |
| 4 | A1 | 432/48 | 22.4 | S1 | 1300 | C1 | 360 | Aqueous solution of 50 mass | 80 |
| | | | | | | | | % magnesium chloride | |
| 5 | A1 | 864/96 | 43.2 | S1 | 900 | C1 | 360 | Aqueous solution of 50 mass | 80 |
| | | | | | | | | % magnesium chloride | |
| 6 | A1 | 1188/132 | 59.5 | S1 | 900 | — | 0 | Aqueous solution of 50 mass | 80 |
| | | | | | | | | % magnesium chloride | |
| 7 | A1 | 1080/240 | 57.9 | S2 | 600 | C1 | 360 | Aqueous solution of 50 mass | 80 |
| | | | | | | | | % magnesium chloride | |
| 8 | A1 | 1080/240 | 57.9 | S1 | 600 | C1 | 360 | Aqueous solution of 10 mass | 60 |
| | | | | | | | | % aluminum sulfate | |
| 9 | A1 | 1080/240 | 57.9 | S1 | 600 | C1 | 360 | Aqueous solution of 50 mass | 110 |
| | | | | | | | | % sodium chloride | |
| 10 | A1 | 1080/240 | 57.9 | S1 | 600 | C1 | 360 | Aqueous solution of 50 mass | 110 |
| | | | | | | | | % potassium chloride | |
| 11 | A1 | 1080/240 | 57.9 | S1 | 600 | C1 | 360 | Aqueous solution of 50 mass | 80 |
| | | | | | | | | % calcium chloride | |
| 12 | A1 | 1080/240 | 57.9 | S3 | 600 | C1 | 360 | Aqueous solution of 50 mass | 80 |
| | | | | | | | | % magnesium chloride | |
| 13 | A1 | 1080/240 | 57.9 | S1 | 600 | C1 | 360 | Aqueous solution of 50 mass | 90 |
| | | | | | | | | % ammonium sulfate | |
| 14 | A2 | 1080/240 | 57.9 | S4 | 600 | C2 | 360 | Aqueous solution of 50 mass | 80 |
| | | | | | | | | % magnesium chloride | |
| 15 | A1 | 1080/240 | 57.9 | S5 | 600 | C1 | 360 | Aqueous solution of 50 mass | 80 |
| | | | | | | | | % magnesium chloride | |

### <Production of Toner Particles and Developer>

### [Production of Toner Particles 1 and Developer 1]

Silica particles 1 were prepared as an external additive to be added to the toner base particles obtained as described above. The prepared silica particles were then added to the toner base particles to obtain toner particles. Furthermore, a ferrite carrier was added to the obtained toner particles to produce a developer. Hereinafter, preparation of silica particles, production of toner particles using the obtained silica particles, and production of a developer will be described.

### (Preparation of Silica Particles)

In a 3-liter reaction vessel equipped with a stirring device, a dropping funnel, and a thermometer, 945 parts by mass of methanol, 45 parts by mass of 28% aqueous ammonia, and 135 parts by mass of water were added and mixed. The temperature of the solution was adjusted to 35° C., 405 parts by mass of tetramethoxysilane was added dropwise thereto over 6 hours with stirring, and after the dropwise addition, stirring was further continued for 1 hour to perform hydrolysis, thereby obtaining a suspension of silica particles. The dispersion liquid was distilled under reduced pressure and dried, and then the fine particles were crushed to obtain silica particles 1.

### (Production of Toner Particles and Production of Developer)

To 100 parts by mass of the toner base particles 1, 1.5 parts by mass of the silica particles 1 were added and mixed by a Henschel mixer (manufactured by Nippon Coke & Engineering Co., Ltd.) at a rotor circumferential speed of 35 mm/sec at 32° C. for 20 minutes. After the mixing, toner particles 1—obtained by removing coarse particles with a sieve having an opening of 45 μm—and a ferrite carrier—coated with an acrylic resin and having a volume-average particle diameter of 32 μm—were added so that the toner particle concentration became 6 mass %, and the toner particles and the ferrite carrier were mixed. Thus, a developer 1, which is a two-component developer containing the toner particles 1, was produced.

### [Production of Toner Particles 2 to 15 and Developers 2 to 15]

Developers 2 to 15 were obtained in the same manner except that the toner base particles 1 were changed to the toner base particles 2 to 15, respectively. Note that the developers 1 to 12 correspond to examples 1 to 12, and the developers 13 to 15 correspond to comparative examples 1 to 3.

### <Evaluation>

For each of the toner particles 1 to 15, the content of a metal element and the content of a sulfur element were measured by X-ray fluorescence analysis. Furthermore, for each of the developer 1 to 15, an image was formed using the image forming apparatus containing the developer, and the low-temperature fixability, the fogging resistance, and the electrostatic sticking resistance were evaluated. Hereinafter, each of them will be described.

### [X-Ray Fluorescence Analysis]

Using ZSX Primus IV (manufactured by Rigaku Corporation), which is a scanning-type X-ray fluorescence analyzer, the amounts of the sulfur element and metal element in the toner particles 1 to 15 were measured. To be specific, 2 g of each of toner particles 1 to 15 of was pressurized and pelletized, and the pellets were set in a ZSX Primus IV. As a quantification method, a fundamental parameter method (FP method) was used. Furthermore, the contents (mass %) of the respective components of each toner were measured and calculated by SQX (Scan QuantX) analysis using an EZ scan mode.

### [Evaluation of Low-Temperature Fixability]

The image forming apparatus used was “bizhub PRESS” (registered trademark) C1070 (manufactured by Konica Minolta Inc), a commercially available digital full-color multifunction peripheral. The multifunction peripheral was modified so that the surface temperature of an upper fixing belt and a lower fixing roller of a fixing device included in the multifunction peripheral can be changed. The multifunction peripheral was also modified so that the fixing temperature, the amount of toner adhesion, and the system speed can be set to any value. Each of the above-described developers 1 to 15 was loaded into the multifunction peripheral, and an image was fixed on NPI high quality (127.9 g/m²) (manufactured by Nippon Paper Industries Co., Ltd.), which is wood-free paper having an A4 size, thereby evaluating the low-temperature fixability. To be specific, the adhesion amount was set to be 10 g/m² and an image of 100 mm×100 mm size was fixed under an environment of normal temperature and normal humidity (temperature: 20° C., moisture: 50% RH). In this fixing experiment, when the set fixing temperature was increased from 110° C. to 180° C. in increments of 2° C., whether or not white spots (image defects due to fixing offset) caused by adhesion of the toner image to the fixing belt occurred was visually confirmed. The lowest temperature at which white spots did not occur was used as the lowest fixing temperature (U. O. avoidance temperature). The lowest fixing temperature was evaluated by the following four grades. Table 3 shows the evaluation results.
⊚: Minimum fixing temperature is lower than 130° C.
∘: Minimum fixing temperature is 130° C. or more and less than 135° C.
Δ: Minimum fixing temperature is 135° C. or more and less than 140° C.
x: Minimum fixing temperature is 140° C. or higher

⊚, ∘, and Δ are regarded as acceptable levels.

### [Evaluation of Fogging Resistance]

Each of the developers 1 to 15 was loaded into the multifunction peripheral described above. Next, 100,000 test images were printed on A4 size wood-free paper (65 g/m²) in a high temperature and high humidity environment (30° C., 80% RH). Note that the test image was a band-shaped solid image having a print coverage of 5%. After the printing of the 10,000 test images, the density of the wood-free paper when an image was formed under a setting in which nothing was printed on the wood-free paper (blank sheet density) was measured. To be specific, the density was measured at 20 positions on A4 wood-free paper, and the average value was used as the blank sheet density. The density measurement was performed using a reflection densitometer “RD-918” (manufactured by Macbeth). A blank sheet density of less than 0.012 was determined to be acceptable. Table 3 shows the evaluation results.
⊚: Less than 0.005
∘: 0.005 or more and less than 0.008
Δ: 0.008 or more and less than 0.012
x: More than 0.012

⊚, ∘, and Δ are regarded as acceptable levels.

### [Evaluation of Electrostatic Sticking Resistance]

For the electrostatic sticking resistance, in order to measure the force with which sheets of paper are electrostatically adhered to each other, the force required for physically peeling the sheets from each other, that is, the “sticking force” was measured. Specifically, each of the developers 1 to 15 was loaded into the multifunction peripheral described above. Then, the single-sided solid image was output on five sheets in the double-sided output mode, and a bundle of sheets on which the five single-sided solid images were superimposed was obtained. Note that the image was output under normal humidity conditions (a temperature of 20° C. and a humidity of 50% RH) and the sheet used was “OK Top Coated Sheet 157 g/m₂” (manufactured by Oji Paper Co., Ltd.) having a A3 size. On the obtained bundle of sheets, 500 sheets of A3 J sheet were placed and left to stand for 2 hours. Thereafter, the bundle of sheets was placed on a flat table, a tape was applied to the leading end of the uppermost sheet, and the uppermost sheet was slowly slid in the horizontal direction. At this time, the sheets below the uppermost sheet were fixed to the table so as not to move. At this time, a force required for sliding the sheet was measured with a spring balance. This measurement was repeated four times in order from the top, and the average value of the force indicated by the spring balance was used as the sticking force. The sticking force was evaluated in the following five grades. When the sticking strength was less than 2.8 N, the sample was practically usable and was determined to be acceptable. Table 3 shows the evaluation results.
⊚: Less than 1.2 N
∘: 1.2 N or more and less than 1.8 N
Δ: 1.8 N or more and less than 2.8 N
x: More than 2.8 N

⊚, ∘, and Δ are regarded as acceptable levels.

TABLE 3

| | | | X-ray fluorescence | | | | | | |
|---|---|---|---|---|---|---|---|---|---|
| | | | analysis of toner | | | | Evaluation | | |
| | | Toner base | particles (mass %) | | | A(Mg)/ | Low-temperature | | Electrostatic |
| | Developer | particle | A | B | A/B | A(total) | fixing (° C.) | Fogging | sticking |
| Example 1 | 1 | 1 | 0.5 | 0.28 | 1.8 | 50.0 | 127 (⊚) | 0.004 (⊚) | 1.0N (⊚) |
| Example 2 | 2 | 2 | 0.5 | 0.28 | 1.8 | 50.0 | 124 (⊚) | 0.003 (⊚) | 1.2N (◯) |
| Example 3 | 3 | 3 | 0.5 | 0.56 | 0.9 | 50.0 | 133 (◯) | 0.002 (⊚) | 1.9N (Δ) |
| Example 4 | 4 | 4 | 0.5 | 0.45 | 1.1 | 50.0 | 130 (◯) | 0.003 (⊚) | 1.5N (◯) |
| Example 5 | 5 | 5 | 0.5 | 0.33 | 1.5 | 50.0 | 128 (⊚) | 0.004 (⊚) | 1.3N (◯) |
| Example 6 | 6 | 6 | 0.5 | 0.45 | 1.1 | 50.0 | 138 (Δ) | 0.003 (⊚) | 1.3N (◯) |
| Example 7 | 7 | 7 | 0.19 | 0.11 | 1.8 | 50.0 | 127 (⊚) | 0.010 (Δ) | 0.6N (⊚) |
| Example 8 | 8 | 8 | 0.5 | 0.28 | 1.8 | 10.0 | 127 (⊚) | 0.010 (Δ) | 0.3N (⊚) |
| Example 9 | 9 | 9 | 0.5 | 0.28 | 1.8 | 10.0 | 127 (⊚) | 0.008 (Δ) | 0.7N (⊚) |
| Example 10 | 10 | 10 | 0.5 | 0.28 | 1.8 | 10.0 | 127 (⊚) | 0.007 (◯) | 0.9N (⊚) |
| Example 11 | 11 | 11 | 0.5 | 0.28 | 1.8 | 10.0 | 127 (⊚) | 0.005 (◯) | 1.1N (⊚) |
| Example 12 | 12 | 12 | 0.5 | 0.33 | 1.5 | 50.0 | 131 (◯) | 0.004 (⊚) | 1.1N (⊚) |
| Comparative | 13 | 13 | 0 | 0.33 | 0 | 50.0 | 127 (⊚) | 0.004 (⊚) | 3.5N (X) |
| example 1 | | | | | | | | | |
| Comparative | 14 | 14 | 0.5 | 0.00 | — | 50.0 | 127 (⊚) | 0.014 (X) | 0.2N (⊚) |
| example 2 | | | | | | | | | |
| Comparative | 15 | 15 | 0.5 | 0.83 | 0.6 | 50.0 | 127 (⊚) | 0.002 (⊚) | 3.2N (X) |
| example 3 | | | | | | | | | |

In each of examples 1 to 12 satisfying 0.8≤A/B, both performances of fogging and electrostatic sticking were at an acceptable level. In contrast, in each of comparative examples 1 to 3 not satisfying 0.8≤A/B, any one of the performances of fogging and electrostatic sticking was unacceptable. It has been found that when 0.8≤A/B is satisfied, the balance between a metal element and a sulfur element is improved, and thus electrostatic sticking can be suppressed while fogging is suppressed.

When example 1 and example 2 are compared, example 1 contains styrene-acrylic resin fine particles, but example 2 does not contain styrene-acrylic resin fine particles (see Table 2). When the performance of example 1 was compared with that of example 2, electrostatic sticking was more suppressed in example 1 (see Table 3). From this, it is considered that when a styrene-acrylic resin is contained as the binder resin, the conductivity of a toner becomes excellent, and the electrostatic sticking is further suppressed.

When example 1 is compared with examples 3 and 4, example 1 contains 50 mass % or more of the amorphous polyester resin based on the total mass of the binder resin, example 3 does not contain the amorphous polyester resin, and example 4 contains a small amount (less than 30 mass %) of the amorphous polyester resin (see Table 2). When the performance of example 1 was compared with that of example 4, the low-temperature fixability was better in example 1 (see Table 3). Furthermore, when the performance of example 3 was compared with that of example 4, the low-temperature fixability of example 4 was better (see Table 3). From this, it is considered that the content of the amorphous polyester resin is preferably 30 mass % or more, and more preferably 50 mass % or more, based on the total mass of the binder resin. This is considered to be because when the amorphous polyester resin is contained in the toner, the ether bond of the main chain rotates when heat is applied at the time of fixing the toner. In addition, it is considered that this is because the amorphous polyester resin has few side chains and does not prevent the rotation of the main chain.

When example 1 is compared with example 6, example 1 includes a crystalline polyester resin, but example 6 does not include a crystalline polyester resin (see Table 2). When the performance of example 1 was compared with that of example 6, the low-temperature fixability was better in example 1 (see Table 3). It is considered that this is because when a crystalline polyester resin is included in a toner, the crystalline polyester melts at once when the crystalline polyester reaches a temperature equal to or higher than the melting point thereof during fixing, thereby plasticizing the surrounding resin.

When the performance of example 1 is compared with that of example 7, A/B is 1.8 in both of example 1 and example 7, but A is 0.5 mass % in example 1 and A is 0.19 mass % in example 7 (see Table 3). When such performances of example 1 and example 7 were compared, fogging was more suppressed in example 1 (see Table 3). It is considered that this is because the amount of the metal element contained is larger in example 1, so that the charge of the toner leaks more. That is, A is preferably 0.2 mass % or more.

In example 1, 50 mass % of magnesium chloride was used as the aggregating agent, whereas in examples 8 to 10, no magnesium chloride was used as the aggregating agent (see Table 2). Specifically, in Example 8, an aqueous solution of 10 mass % of aluminum sulfate was used as the aggregating agent. In Example 9, an aqueous solution of 50 mass % of sodium chloride was used as the aggregating agent. In example 10, an aqueous solution of 50 mass % of potassium chloride was used as the aggregating agent. Thus, when example 1 is compared with examples 8 to 10, the mass % of the Mg element based on the total mass of the metal elements (A (Mg)/A (total)) is 30 mass % or more in example 1, whereas it is less than 30 mass % in examples 8 to 10 (see Table 3). When the performance of example 1 is compared with those of examples 8 to 10, fogging was more suppressed while the electrostatic sticking was sufficiently suppressed in example 1. Therefore, the mass % of the Mg element based on the total mass of the metal elements is preferably 30 mass % or more.

Example 1 includes a hydrocarbon wax as a release agent, while Example 12 includes an ester wax as a release agent (see Tables 1 to 3). When example 1 is compared with example 12, the low-temperature fixability was better in example 1. This is considered to be because when a hydrocarbon wax having a low polarity is used, the wax is more likely to exude from the toner at the time of fixing, so that the separability from the fixing belt is improved and the low-temperature fixability is excellent.

### INDUSTRIAL APPLICABILITY

The toner of the present invention is useful for suppressing sticking between recording media having images formed thereon due to electrostatic force while suppressing the occurrence of fogging.

Although embodiments of the present invention have been described in detail, it is clearly understood that the same is by way of example only and not limitation, the scope of the present invention should be interpreted by terms of the appended claims.

What is claimed is:

1. A toner, comprising:
a binder resin;
at least one metal element selected from an alkali metal, an alkaline earth metal, and aluminum; and
a sulfur element;
wherein
when a mass % of the at least one metal element based on a total mass of the toner as measured by X-ray fluorescence analysis is A mass % and a mass % of the sulfur element based on the total mass is B mass %, the toner satisfies 0.8≤A/B.

2. The toner according to claim 1, comprising a styrene-acrylic resin as the binder resin.

3. The toner according to claim 1, further comprising an amorphous polyester resin in an amount of 30 mass % or more based on a total mass of the binder resin.

4. The toner according to claim 1, further comprising an amorphous polyester resin in an amount of 50 mass % or more based on a total mass of the binder resin.

5. The toner according to claim 1, comprising a crystalline polyester resin as the binder resin.

6. The toner according to claim 1, wherein the A mass % is 0.2 mass % or more.

7. The toner according to claim 1, wherein a mass % of an Mg element based on a total mass of the at least one metal element is 30 mass % or more.

8. The toner according to claim 1, wherein at least a part of the sulfur element is derived from potassium persulfate.

9. The toner according to claim 1, further comprising a hydrocarbon wax as a release agent.

10. An image forming apparatus, comprising the toner according to claim 1.

11. An image-formed product obtained by using the toner according to claim 1.

12. A method for producing the toner according to claim 1, the method comprising:
polymerizing a monomer for synthesizing the binder resin by using potassium persulfate as a polymerization initiator.
